(19) United States
(12) Patent Application Publication
(10) Pub. No.: US 2026/0027512 A1
(43) Pub. Date: Jan. 29, 2026

(54) SOLID-PHASE LIQUID MEMBRANE METHOD FOR PURIFYING NITROGEN OXIDE WASTE GAS

(71) Applicant: ZHEJIANG UNIVERSITY OF TECHNOLOGY, Zhejiang (CN)

(72) Inventors: Hanfeng LU, Zhejiang (CN); Ying ZHOU, Zhejiang (CN); Quanli KE, Zhejiang (CN); Huayan LIU, Zhejiang (CN); Guokai Cui, Zhejiang (CN)

(73) Assignee: ZHEJIANG UNIVERSITY OF TECHNOLOGY, Zhejiang (CN)

(21) Appl. No.: 19/344,458

(22) Filed: Sep. 29, 2025

Related U.S. Application Data
(63) Continuation of application No. PCT/CN2024/080928, filed on Mar. 11, 2024.

(30) Foreign Application Priority Data
Jun. 6, 2023 (CN) 202310661948.0

(51) Int. Cl. B01D 53/14; B01J 20/28

(52) U.S. Cl. CPC B01D 53/1431; B01J 20/28033; B01D 2257/404

(57) ABSTRACT

A solid-phase liquid membrane method for purifying nitrogen oxide waste gases, using ozone, ClO₂ or O₂ to partially oxidize NOₓ components in a flue gas into NO₂—NO mixed flue gas, which is then passed into an absorption bed filled with an absorption material, to absorb and remove nitrogen oxides; the absorption material comprises a porous solid-phase material and an absorption liquid membrane loaded thereon, a mass ratio (solid-liquid ratio) of the porous solid phase material to the liquid membrane being 1:(0.05-10); the liquid membrane is primarily composed of three parts: a pH value regulator, a liquid membrane forming agent and a liquid membrane stabilizer, the pH value regulator comprising an organic base and an inorganic base, the liquid membrane stabilizer comprising urea, and the liquid membrane forming agent comprising water and C1-C4 lower alcohols.

### CROSS-REFERENCE TO RELATED APPLICATION

This application is a continuation of international application of PCT application serial no. PCT/CN2024/080928, filed on Mar. 11, 2024, which claims the priority benefit of China application no. 202310661948.0, filed on Jun. 6, 2023. The entirety of each of the above-mentioned patent applications is hereby incorporated by reference herein and made a part of this specification.

### TECHNICAL FIELD

The present disclosure relates to the technical field of treatment for nitrogen oxides in flue gases, and in particular to, a solid-phase liquid membrane method for purifying nitrogen oxide waste gases.

### BACKGROUND OF RELATED ART

A nitrogen oxide (NOₓ) waste gas, as one of the primary pollutants in atmospheric pollution, may cause phenomena such as acid rain and photochemical smog, which poses varying degrees of harm to human health and the living environment. In order to reduce pollution of the atmospheric environment, relevant policies and standards for controlling NOₓ pollutant emissions have been issued and implemented in China, and the requirements for NOₓ emissions have become increasingly stringent. The Work Plan for the Comprehensive Implementation of Ultra-Low Emission and Energy-Saving Transformation in Coal-Fired Power Plants issued by the Ministry of Ecology and Environment (MEE) of China requires that coal-fired power plants reduce nitrogen oxide emission concentrations to less than 50 mg/m³ nationwide. Therefore, it is necessary to perform efficient denitration treatment on the nitrogen oxide waste gas in industry, which is of great significance for improving the environmental quality and practicing the concept of green development.

Existing denitration technologies mainly include dry processes and wet processes. The dry processes include selective catalytic reduction (SCR), selective non-catalytic reduction (SNCR), selective non-catalytic reduction-selective catalytic reduction (SNCR-SCR), an activated carbon method, a plasma method, and the like; and the wet processes include an alkali solution absorption method, an acid absorption method, a complexation absorption method, a reduction absorption method, an oxidation absorption method, and the like. Among the widely used dry denitration technologies in industrial applications, the dominant method is SCR, the principle of which is as follows: spraying a liquid ammonia solution into a high-temperature flue gas, and then reducing nitrogen oxides in the flue gas to N₂ under the action of a catalyst; and among the wet denitration technologies, the dominant method is the oxidation absorption method, the principle of which is mainly as follows: oxidizing NO in the flue gas into water-soluble high-valence nitrogen oxides for liquid-phase absorption.

According to the temperature ranges of the flue gases in industry, the flue gases may be divided into high-temperature flue gases (450-800° C.), medium-temperature flue gases (300-450° C.), medium- and low-temperature flue gases (160-300° C.), low-temperature flue gases (60-160° C.), and ultra-low-temperature flue gases (20-60° C.).

The SNCR method is generally employed for the high-temperature flue gases; the SCR method is generally employed for the medium-temperature and medium- and low-temperature flue gases; for the low-temperature and ultra-low-temperature flue gases (<160° C.), if a flue gas temperature elevation SCR (SCR requires a flue gas temperature of higher than 160° C.) method is employed, the energy consumption will significantly increase. The wet oxidation absorption technology is a relatively feasible low-temperature denitration technology. However, in the wet denitration technology, the absorbent liquid is prone to volatilization, which reduces the efficiency. Moreover, due to the gas-liquid mass transfer influence, wet denitration requires stringent equipment and shows limited efficiency. Therefore, neither the SCR method nor the wet oxidation denitration technology can solve the low-temperature denitration problem well, and efficient denitration of low-temperature flue gases remains a bottleneck that urgently needs to be solved.

For room temperature flue gases, Chinese Invention Patent No. CN103977680A discloses a denitration method for low concentration NOₓ pollutants emitted from semi-closed spaces such as a road tunnel and an underground parking garage. Under the action of a high-performance normal-temperature NO oxidation catalyst, low-concentration NOₓ is absorbed by a solid base absorbent. However, the efficiency of this technology is low (approximately 10-40%), which interferes with its wide application. This technology is not applied. Patent Publication No. CN104190223A provides a liquid-phase oxidation flue gas desulfurization and denitration absorption process and device. Nitrogen oxides in the flue gas are removed by employing a three-stage absorption method. In the first stage, in order to avoid consumption of the oxidizing agent by SO₂, prewashing is performed. In the second stage, oxidative absorption is performed by using the oxidizing agent such as ozone. In the third stage, only a single alkaline absorption liquid is used for absorption, with a denitration efficiency of only 85% and an outlet nitrogen oxide concentration exceeding 300 mg/m³. Patent Publication No. CN1768902A provides an ozone oxidative denitration method for boiler flue gas. First, NO in the boiler flue gas is first oxidized with ozone to form a water-soluble high-valence nitrogen oxide, and then the water-soluble high-valence nitrogen oxide is absorbed with alkali liquor. However, in this process, the utilization ratio of the alkali liquor absorbent is relatively low, and the denitration efficiency is lower than 80%.

In conclusion, in order to solve the technical problem of low-temperature flue gas denitration in a prioritized manner, the present disclosure develops a method and a process capable of efficiently purifying the nitrogen oxide waste gas at low temperatures (<160° C.) by employing a solid-phase liquid membrane absorption technology. In a case where deficiencies in the prior art are overcome, the method and process have high denitration efficiency, strong economic applicability, and great operation convenience, thereby having a relatively broad application prospect.

### SUMMARY OF THE INVENTION

An objective of the present disclosure is to provide a method for efficiently purifying a nitrogen oxide at low temperatures (<160° C.) by employing a solid-phase liquid membrane method. NO is partially oxidized into NO₂ by an oxidation method, and then NO₂ is absorbed by employing a high specific surface area solid material containing an absorbent liquid film on the surface, so that the emission concentration of nitrogen oxide is reduced to less than 50 mg/m³.

In order to achieve the above objective, the present disclosure adopts the following technical solutions:

A solid-phase liquid membrane method for purifying nitrogen oxide waste gases, including the following steps:
(1) continuously introducing a NOₓ-containing flue gas with different initial concentrations into a flue gas oxidation device, and partially oxidizing the NOₓ-containing flue gas into a NO₂—NO mixed flue gas by means of oxidation methods such as ozone (O₃) oxidation, ClO₂ oxidation, and O₂ oxidation;
(2) absorbing and removing the oxidized NOₓ-containing flue gas by means of an absorption bed filled with an absorption material, where an absorbent material is a porous solid material containing a liquid membrane, and performing absorption at different NO₂—NO proportions, different NOₓ concentrations, different temperatures, different absorption space velocities, different solid-liquid ratios of absorbent, and different absorbents, where the flue gas after absorption meets an emission condition and is emitted;
(3) the porous solid phase material combined with the liquid membrane mainly consists of the liquid membrane with absorption performance and the porous solid phase material that are combined, where a mass ratio (solid-liquid ratio) of the porous solid phase material to the liquid membrane is 1:(0.05-10);
(4) the absorption liquid membrane is a composite solution that is formed by combining a pH value regulator, a liquid membrane forming agent, and a liquid membrane stabilizer, and has a strong absorption capacity for NOₓ;
(5) the pH value regulator accounts for 2-8% of the total mass of the liquid membrane and mainly includes an organic base and an inorganic base, where the inorganic base mainly includes one or more of NaOH, Na₂CO₃, KOH, K₂CO₃, Na₂S, and the like; and the organic base mainly includes one or more of organic amines such as ethanolamine, diethanolamine, and triethanolamine;
(6) the liquid membrane forming agent mainly includes water and C1-C4 lower alcohols, where the C1-C4 lower alcohols are one or more of ethylene glycol, propylene glycol, glycerol, butylene glycol, and the like; a mass ratio of the water to the C1-C4 lower alcohols is 1:(0.05-0.5);
(7) the liquid membrane stabilizer accounts for 0.5-4% of the total mass of the liquid membrane and mainly includes urea and an additive, where the additive is selected from one or more of NaCl, CaCl₂, NaHCO₃, EDTA, Na₂SO₃, and the like, the liquid membrane stabilizer includes urea, and one or more additional components may be added to improve the NOₓ absorption stability; and
(8) a porous liquid membrane immobilized carrier mainly includes porous materials such as activated carbon, macroporous resin, a molecular sieve or porous alumina beads, and the like. The specific surface area of the porous materials is >50 m²/g. The materials shall have good microporous and mesoporous structures.

Further, the composite solution that is formed by combining the pH value regulator, the liquid membrane forming agent, and the liquid membrane stabilizer, and has a strong absorption capacity to NOₓ is combined with the porous carrier, such that anions on the surface interact with the carrier to form a liquid membrane that is uniformly dispersed on the surface. This liquid membrane is a dominant absorption material. The porous liquid membrane immobilized carrier is used to capture the NOₓ component in the gas phase, and the NOₓ component is absorbed and removed by the liquid membrane.

According to the present disclosure, the used components of the liquid membrane include various pH value regulators, various liquid membrane forming agents, and various liquid membrane stabilizers.

According to the present disclosure, preferably, the pH value regulator uses the organic base and the inorganic base simultaneously. The inorganic base may regulate the pH value faster. While regulating the pH value, the organic base may be combined with the liquid membrane forming agent to form a more stable liquid membrane structure. The most preferable absorption component is the pH value regulator formed by three substances: NaOH, Na₂S, and ethanolamine. The total mass of the pH value regulator accounts for 1-6% of the total mass of the liquid membrane, preferably 4.8-5.5%.

According to the present disclosure, by adding the liquid membrane stabilizer, the stability of the liquid membrane may be improved, the absorption efficiency may be improved, and the effective time of absorption may be prolonged. The addition of the urea can significantly improve the stability of the absorbent. The most preferable liquid membrane stabilizer is formed by adding urea and NaHCO₃ in a mixed manner. The mass ratio of the urea to the additive is 1:(0.3-2), preferably 1:(0.5-1). The total mass of the liquid membrane stabilizer accounts for 1-2% of the total mass of the liquid membrane.

According to the present disclosure, preferably, the liquid membrane forming agent is a mixed solution consisting of water and C1-C4 lower alcohols. The mass ratio of water to polyhydric alcohols is 1:(0.2-1.5), preferably 1:(0.1-0.3), more preferably 1:0.2. Most preferably, the liquid membrane forming agent is a mixed solution consisting of water and propylene glycol.

According to the present disclosure, the porous material that has good microporous and mesoporous structures and a specific surface area of >50 m²/g is used in the present disclosure. In addition to immobilizing the liquid membrane, the carrier also has a capturing function by employing the porous material and has an absorption function combined with the liquid membrane. During absorption, the carrier plays a very important role. In an actual operation, the specific surface area of the carrier is preferably >500 m²/g, most preferably >1,000 m²/g.

Further, after passing through the flue gas oxidation device, the volume ratio of NO₂/NO in the flue gas is 1:10-1:0.01, and there is no occurrence of oxidant escape, thus avoiding secondary pollution.

Further, the components to be removed in the NOₓ-containing flue gas are NO and NO₂, and the initial NOₓ concentration is 10-2,000 mg/m³.

According to the present disclosure, preferably, the volume ratio of NO₂/NO in the flue gas is 1:5-1:0.1, more preferably 1:(1-0.1). The initial NOₓ concentration is preferably 50-1,500 mg/m³, more preferably 50-500 mg/m³.

Further, an absorption temperature is 0-160° C., and an absorption space velocity is 1,000-1,000,000 h⁻¹.

Further, a mass ratio (a solid-liquid ratio) of the porous solid phase material to the liquid membrane is 1:(0.05-10), preferably 1:(0.05-5).

According to the present disclosure, preferably, the absorption temperature is 40-120° C.

According to the present disclosure, preferably, the absorption space velocity is 1,000-200,000 h⁻¹.

Compared with the prior art, the present disclosure has the following beneficial effects:
(1) The solid phase liquid membrane method combines the solid with the liquid to remove the nitrogen oxides, overcomes the deficiencies of the single solid and the single liquid in terms of nitrogen oxide removal efficiency, applicable temperature, cost, and other aspects, and can treat the nitrogen oxide waste gas at relatively low temperatures (0-160° C.) to achieve a removal efficiency of over 95%, so that the emission concentration of nitrogen oxide is reduced to less than 50 mg/m³, which meets the requirement for ultra-low emission.
(2) High industrial applicability and adaptability: this method has a relatively low equipment requirement, the denitration efficiency is less affected as the device changes, the situation where the industrial applicability is poor due to the influence of gas liquid mass transfer on efficiency in wet denitration is avoided, and this method can be suitable for most NOₓ-containing flue gases requiring denitration.

The present disclosure provides a liquid-phase absorption and purification method for industrial nitrogen oxide flue gases. This method has the advantages of high low-temperature denitration efficiency, simple operation, economic feasibility, greenness and safety, and the like, and is quite promising in terms of industrial denitration.

### BRIEF DESCRIPTION OF THE DRAWINGS

FIGURE is a pore size distribution diagram of a porous liquid membrane immobilized carrier-activated carbon.

### DETAILED DESCRIPTION OF THE EMBODIMENTS

The present disclosure will be further described below in conjunction with specific examples, but the protection scope of the present disclosure is not limited thereto.

### EXAMPLES

In an example of the present disclosure, a porous solid material combined with a liquid membrane is used as an absorbent to efficiently remove nitrogen oxides from flue gas at relatively low temperatures (0-160° C.).

In this example, a solid-phase liquid membrane method for purifying nitrogen oxide waste gases includes the following steps:

The present disclosure will be further described below in conjunction with specific examples, but the protection scope of the present disclosure is not limited thereto.
(1) a NOₓ-containing flue gas is introduced into a flue gas oxidation device, and a certain amount of ozone (O₃) is introduced as well to partially oxidize NOₓ in the flue gas;
(2) the oxidized NOₓ-containing flue gas is absorbed and denitrated through an absorption bed;
(3) a concentration Cᵢₙ at a flue inlet and a concentration Cₒᵤₜ at a flue outlet are detected by employing a flue gas analyzer, a concentration difference is determined, and absorption efficiency is calculated using Formula 1;
(4) the denitrated flue gas which meets an emission requirement is emitted from the flue outlet; and
(5) the composition of the liquid membrane is changed, the porous liquid membrane immobilized carrier absorbs the flue gas at different NO₂—NO proportions, different NOₓ concentrations, different temperatures, different absorption space velocities, different solid-liquid ratios of absorbent, and different absorbents, and the absorption capacity of the porous material with the immobilized liquid membrane for different flue gases is tested.

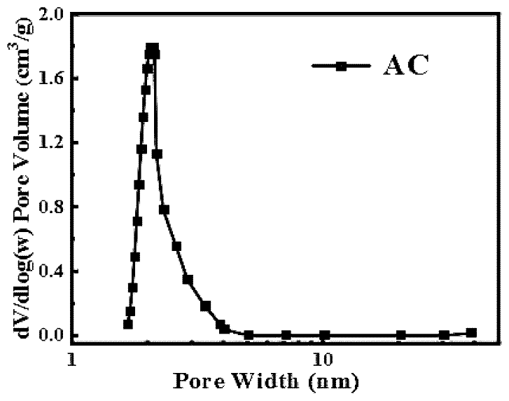

The porous liquid membrane immobilized carrier used in this example mainly includes porous materials such as activated carbon, macroporous resin, a molecular sieve, or porous alumina beads, and the like. The specific surface area of the porous materials is >50 m²/g. The materials shall have good microporous and mesoporous structures. The used activated carbon has microporous or mesoporous structures, the pore sizes in the porous size distribution diagram focus on 1-3 nm, the specific surface area is 887.4 m²/g, and the average pore size is 1.88 nm. FIG. 1 is a pore size distribution diagram of a porous liquid membrane immobilized carrier-activated carbon (AC).

$$η = \frac{{c}_{in} - {c}_{out}}{{c}_{in}} \times 100 \% \qquad Formula 1$$

η is the absorption efficiency (%), Cᵢₙ is the inlet NOₓ concentration (mg/m³) measured at the flue inlet, and Cₒᵤₜ is the NOₓ concentration (mg/m³) measured at the flue outlet.

### Example 1

Taking a flue gas with a NOₓ concentration of 500 mg/m³ as an example, the flue gas was introduced into a flue gas oxidation device, 660 mg/m³ O₃ was introduced to oxidize the flue gas, and a post-oxidation flue gas with NO₂/NO volume ratio of 1:0.2 was introduced to an absorption tower to perform reactive absorption with a porous material with an immobilized liquid membrane through an absorption bed. The liquid membrane loaded on the porous material is composed of three parts: a pH value regulator, a liquid membrane forming agent and a liquid membrane stabilizer.

The pH value regulator mainly consists of an organic base and an inorganic base, where the inorganic base mainly includes one or more of NaOH, Na₂CO₃, KOH, K₂CO₃, Na₂S, and the like; and the organic base mainly includes one or more of organic amines such as ethanolamine, diethanolamine, triethanolamine, and N-methyldiethanolamine, the components are added at equal mass ratios, and the pH value regulator accounts for 5% of the total mass of the liquid membrane. The liquid membrane forming agent consisting of water and propylene glycol (mass ratio=1:0.2) is taken as an example. The liquid membrane stabilizer taking urea and NaHCO₃ as an example accounts for 2% of the total mass of the liquid membrane, and the components are added at equal mass ratios. Taking the porous liquid membrane immobilized carrier which was activated carbon as an example, absorption was performed under the conditions taking 80° C., absorption space velocity=50,000 h⁻¹, and solid-liquid ratio of absorbent=1:0.5 (i.e., the mass ratio of the porous material to the liquid membrane is 1:0.5, similarly hereinafter) as an example, the NOₓ concentrations at the inlet and outlet were detected and analyzed by employing a flue gas analyzer (Testo 350), and the absorption efficiency was calculated.

TABLE 1
Purification efficiency of pH value regulator with different inorganic bases

| | Liquid membrane components | | | | |
|---|---|---|---|---|---|
| | | | Liquid | Liquid | |
| | pH value regulator | | membrane | membrane | Absorption |
| No. | Inorganic base | Organic base | forming agent | stabilizer | efficiency |
| 1 | — | Ethanolamine | Water, propylene | Urea, | 38.63% |
| | | | glycol | NaHCO₃ | |
| 2 | NaOH | Ethanolamine | Water, propylene | Urea, | 87.02% |
| | | | glycol | NaHCO₃ | |
| 3 | Na₂CO₃ | Ethanolamine | Water, propylene | Urea, | 75.83% |
| | | | glycol | NaHCO₃ | |
| 4 | KOH | Ethanolamine | Water, propylene | Urea, | 90.94% |
| | | | glycol | NaHCO₃ | |
| 5 | K₂CO₃ | Ethanolamine | Water, propylene | Urea, | 82.79% |
| | | | glycol | NaHCO₃ | |
| 6 | Na₂S | Ethanolamine | Water, propylene | Urea, | 97.73% |
| | | | glycol | NaHCO₃ | |
| 7 | NaOH, Na₂CO₃ | Ethanolamine | Water, propylene | Urea, | 95.42% |
| | | | glycol | NaHCO₃ | |
| 8 | NaOH, KOH | Ethanolamine | Water, propylene | Urea, | 97.19% |
| | | | glycol | NaHCO₃ | |
| 9 | NaOH, K₂CO₃ | Ethanolamine | Water, propylene | Urea, | 94.97% |
| | | | glycol | NaHCO₃ | |
| 10 | NaOH, Na₂S | Ethanolamine | Water, propylene | Urea, | 98.82% |
| | | | glycol | NaHCO₃ | |
| 11 | Na₂CO₃, KOH | Ethanolamine | Water, propylene | Urea, | 94.28% |
| | | | glycol | NaHCO₃ | |
| 12 | Na₂CO₃, K₂CO₃ | Ethanolamine | Water, propylene | Urea, | 94.22% |
| | | | glycol | NaHCO₃ | |
| 13 | Na₂CO₃, Na₂S | Ethanolamine | Water, propylene | Urea, | 97.59% |
| | | | glycol | NaHCO₃ | |
| 14 | KOH, K₂CO₃ | Ethanolamine | Water, propylene | Urea, | 94.11% |
| | | | glycol | NaHCO₃ | |
| 15 | KOH, Na₂S | Ethanolamine | Water, propylene | Urea, | 98.90% |
| | | | glycol | NaHCO₃ | |
| 16 | K₂CO₃, Na₂S | Ethanolamine | Water, propylene | Urea, | 98.07% |
| | | | glycol | NaHCO₃ | |
| 17 | NaOH, Na₂CO₃, KOH | Ethanolamine | Water, propylene | Urea, | 97.55% |
| | | | glycol | NaHCO₃ | |
| 18 | NaOH, Na₂CO₃, K₂CO₃ | Ethanolamine | Water, propylene | Urea, | 98.56% |
| | | | glycol | NaHCO₃ | |
| 19 | NaOH, Na₂CO₃, Na₂S | Ethanolamine | Water, propylene | Urea, | 98.35% |
| | | | glycol | NaHCO₃ | |
| 20 | Na₂CO₃, KOH, K₂CO₃ | Ethanolamine | Water, propylene | Urea, | 97.69% |
| | | | glycol | NaHCO₃ | |
| 21 | Na₂CO₃, KOH, Na₂S | Ethanolamine | Water, propylene | Urea, | 97.42% |
| | | | glycol | NaHCO₃ | |
| 22 | KOH, K₂CO₃, Na₂S | Ethanolamine | Water, propylene | Urea, | 98.72% |
| | | | glycol | NaHCO₃ | |
| 23 | NaOH, Na₂CO₃, KOH, | Ethanolamine | Water, propylene | Urea, | 97.62% |
| | K₂CO₃ | | glycol | NaHCO₃ | |
| 24 | NaOH, Na₂CO₃, KOH, | Ethanolamine | Water, propylene | Urea, | 98.25% |
| | Na₂S | | glycol | NaHCO₃ | |
| 25 | NaOH, Na₂CO₃, KOH, | Ethanolamine | Water, propylene | Urea, | 97.74% |
| | K₂CO₃, Na₂S | | glycol | NaHCO₃ | |

TABLE 2
Purification efficiency of pH value regulator with different organic bases

| | Liquid membrane components | | | | |
|---|---|---|---|---|---|
| | | | Liquid | Liquid | |
| | pH value regulator | | membrane | membrane | Absorption |
| No. | Inorganic base | Organic base | forming agent | stabilizer | efficiency |
| 1 | NaOH, Na₂S | — | Water, propylene | Urea, | 36.01% |
| | | | glycol | NaHCO₃ | |
| 2 | NaOH, Na₂S | Ethanolamine | Water, propylene | Urea, | 98.82% |
| | | | glycol | NaHCO₃ | |
| 3 | NaOH, Na₂S | Diethanolamine | Water, propylene | Urea, | 87.33% |
| | | | glycol | NaHCO₃ | |
| 4 | NaOH, Na₂S | Triethanolamine | Water, propylene | Urea, | 87.26% |
| | | | glycol | NaHCO₃ | |
| 5 | NaOH, Na₂S | Ethanolamine, | Water, propylene | Urea, | 95.28% |
| | | diethanolamine | glycol | NaHCO₃ | |
| 6 | NaOH, Na₂S | Ethanolamine, | Water, propylene | Urea, | 94.86% |
| | | triethanolamine | glycol | NaHCO₃ | |
| 7 | NaOH, Na₂S | Diethanolamine, | Water, propylene | Urea, | 87.46% |
| | | triethanolamine | glycol | NaHCO₃ | |
| 8 | NaOH, Na₂S | Ethanolamine, | Water, propylene | Urea, | 96.90% |
| | | diethanolamine, | glycol | NaHCO₃ | |
| | | triethanolamine | | | |

### Example 2

Taking a flue gas with a NOₓ concentration of 500 mg/m³ as an example, the flue gas was introduced into a flue gas oxidation device, 660 mg/m³ O₃ was introduced to oxidize the flue gas, and taking a volume ratio of NO₂/NO after oxidation, which was 1:0.2 as an example, the oxidized flue gas was introduced to an absorption tower to perform reactive absorption with a porous material with an immobilized liquid membrane through an absorption bed. The liquid membrane loaded on the porous material is composed of three parts: a pH value regulator, a liquid membrane forming agent and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent is composed of water and one or more of C1-C4 lower alcohols such as ethylene glycol, propylene glycol, glycerol, and butylene glycol, where in the liquid membrane forming agent composed of water and the C1-C4 lower alcohols, the mass ratio of water to C1-C4 lower alcohols is 1:0.2. The liquid membrane stabilizer taking urea and NaHCO₃ as an example accounts for 2% of the total mass of the liquid membrane, and the components are added at equal mass ratios. Taking the porous liquid membrane immobilized carrier, which was activated carbon as an example, absorption was performed under the conditions taking 80° C., absorption space velocity=50,000 h⁻¹, and solid-liquid ratio of absorbent=1:0.5 as an example, the NOₓ concentrations at the inlet and outlet were detected and analyzed by employing a flue gas analyzer (Testo 350), and the absorption efficiency was calculated.

TABLE 3
Purification efficiency of different liquid membrane forming agents

| | Liquid membrane components | | | |
|---|---|---|---|---|
| | | Liquid membrane | Liquid membrane | Absorption |
| No. | pH value regulator | forming agent | stabilizer | efficiency |
| 1 | NaOH, Na₂S, ethanolamine | Water | Urea, NaHCO₃ | 76.03% |
| 2 | NaOH, Na₂S, ethanolamine | Ethylene glycol | Urea, NaHCO₃ | 52.10% |
| 3 | NaOH, Na₂S, ethanolamine | Propylene glycol | Urea, NaHCO₃ | 58.70% |
| 4 | NaOH, Na₂S, ethanolamine | Glycerol | Urea, NaHCO₃ | 59.83% |
| 5 | NaOH, Na₂S, ethanolamine | Butylene glycol | Urea, NaHCO₃ | 45.62% |
| 6 | NaOH, Na₂S, ethanolamine | Water, ethylene glycol | Urea, NaHCO₃ | 92.92% |
| 7 | NaOH, Na₂S, ethanolamine | Water, propylene | Urea, NaHCO₃ | 98.82% |
| | | glycol | | |
| 8 | NaOH, Na₂S, ethanolamine | Water, glycerol | Urea, NaHCO₃ | 90.61% |
| 9 | NaOH, Na₂S, ethanolamine | Water, butylene glycol | Urea, NaHCO₃ | 89.33% |

### Example 3

Taking a flue gas with a NOₓ concentration of 500 mg/m³ as an example, the flue gas was introduced into a flue gas oxidation device, 660 mg/m³ O₃ was introduced to oxidize the flue gas, and taking a volume ratio of NO₂/NO after oxidation, which was 1:0.2 as an example, the oxidized flue gas was introduced to an absorption tower to perform reactive absorption with a porous material with an immobilized liquid membrane through an absorption bed; and the liquid membrane loaded on the porous material is composed of a pH value regulator, a liquid membrane forming agent, and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent consisting of water and propylene glycol (mass ratio=1:0.2) is taken as an example. The liquid membrane stabilizer is urea or one or more of urea, NaCl, CaCl₂), NaHCO₃, EDTA, and Na₂SO₃, where the liquid membrane stabilizer accounts for 2% of the total mass of the liquid membrane and the components are added at equal mass ratios. Taking the porous liquid membrane immobilized carrier which was activated carbon as an example, absorption was performed under the conditions taking 80° C., absorption space velocity=50,000 h⁻¹, and solid-liquid ratio of absorbent=1:0.5 as an example, the NOₓ concentrations at the inlet and outlet were detected and analyzed by employing a flue gas analyzer (Testo 350), and the absorption efficiency was calculated.

TABLE 4
Purification efficiency of different liquid membrane stabilizers

| | Liquid membrane components | | | |
|---|---|---|---|---|
| | | Liquid membrane | Liquid membrane | Absorption |
| No. | pH value regulator | forming agent | stabilizer | efficiency |
| 1 | NaOH, Na₂S, ethanolamine | Water, propylene glycol | — | 75.11% |
| 2 | NaOH, Na₂S, ethanolamine | Water, propylene glycol | Urea | 85.76% |
| 3 | NaOH, Na₂S, ethanolamine | Water, propylene glycol | Urea, NaCl | 94.59% |
| 4 | NaOH, Na₂S, ethanolamine | Water, propylene glycol | Urea, CaCl₂ | 93.38% |
| 5 | NaOH, Na₂S, ethanolamine | Water, propylene glycol | Urea, NaHCO₃ | 98.82% |
| 6 | NaOH, Na₂S, ethanolamine | Water, propylene glycol | Urea, EDTA | 91.07% |
| 7 | NaOH, Na₂S, ethanolamine | Water, propylene glycol | Urea, Na₂SO₃ | 94.20% |
| 8 | NaOH, Na₂S, ethanolamine | Water, propylene glycol | Urea, NaCl, CaCl₂ | 95.94% |
| 9 | NaOH, Na₂S, ethanolamine | Water, propylene glycol | Urea, NaCl, NaHCO₃ | 99.18% |
| 10 | NaOH, Na₂S, ethanolamine | Water, propylene glycol | Urea, NaCl, EDTA | 93.37% |
| 11 | NaOH, Na₂S, ethanolamine | Water, propylene glycol | Urea, NaCl, Na₂SO₃ | 96.24% |
| 12 | NaOH, Na₂S, ethanolamine | Water, propylene glycol | Urea, CaCl₂, NaHCO₃ | 98.82% |
| 13 | NaOH, Na₂S, ethanolamine | Water, propylene glycol | Urea, CaCl₂, EDTA | 95.68% |
| 14 | NaOH, Na₂S, ethanolamine | Water, propylene glycol | Urea, CaCl₂, Na₂SO₃ | 96.70% |
| 15 | NaOH, Na₂S, ethanolamine | Water, propylene glycol | Urea, NaHCO₃, EDTA | 99.94% |
| 16 | NaOH, Na₂S, ethanolamine | Water, propylene glycol | Urea, NaHCO₃, Na₂SO₃ | 99.18% |

### Example 4

Taking a flue gas with a NOₓ concentration of 500 mg/m³ as an example, the flue gas was introduced into a flue gas oxidation device, 660 mg/m³ O3 was introduced to oxidize the flue gas, and taking a volume ratio of NO₂/NO after oxidation, which was 1:0.2 as an example, the oxidized flue gas was introduced to an absorption tower to perform reactive absorption with a porous material with an immobilized liquid membrane through an absorption bed; and the liquid membrane loaded on the porous material is composed of a pH value regulator, a liquid membrane forming agent, and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent consisting of water and propylene glycol (mass ratio=1:0.2) is taken as an example. The liquid membrane stabilizer taking urea and NaHCO₃ as an example accounts for 2% of the total mass of the liquid membrane, and the components are added at equal mass ratios. The porous liquid membrane immobilized carrier was composed of activated carbon, macroporous resin, a molecular sieve, and porous alumina beads; absorption was performed under the conditions taking 80° C., absorption space velocity=50,000 h⁻¹, and solid-liquid ratio of absorbent=1:0.5 as an example, the NOₓ concentrations at the inlet and outlet were detected and analyzed by employing a flue gas analyzer (Testo 350), and the absorption efficiency was calculated.

TABLE 5
Purification efficiency of different porous liquid membrane immobilized

| | Liquid membrane components | | | Porous liquid | |
|---|---|---|---|---|---|
| | | Liquid | Liquid | membrane | |
| | pH value | membrane | membrane | immobilized | Absorption |
| No. | regulator | forming agent | stabilizer | carrier | efficiency |
| 1 | NaOH, Na₂S, | Water, propylene | Urea, | Activated | 98.82% |
| | ethanolamine | glycol | NaHCO₃ | carbon | |
| 2 | NaOH, Na₂S, | Water, propylene | Urea, | Macroporous | 74.88% |
| | ethanolamine | glycol | NaHCO₃ | resin | |
| 3 | NaOH, Na₂S, | Water, propylene | Urea, | Molecular | 66.16% |
| | ethanolamine | glycol | NaHCO₃ | sieve | |
| 4 | NaOH, Na₂S, | Water, propylene | Urea, | Porous | 40.88% |
| | ethanolamine | glycol | NaHCO₃ | alumina beads | |

### Example 5

Taking a flue gas with a NOₓ concentration of 500 mg/m³ as an example, the flue gas was introduced into a flue gas oxidation device, 660 mg/m³ O₃ was introduced to oxidize the flue gas, and taking a volume ratio of NO₂/NO after oxidation, which was 1:0.2 as an example, the oxidized flue gas was introduced to an absorption tower to perform reactive absorption with a porous material with an immobilized liquid membrane through an absorption bed. The liquid membrane loaded on the porous material is composed of three parts: a pH value regulator, a liquid membrane forming agent and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent consisting of water and propylene glycol (mass ratio=1:0.2) is taken as an example. The liquid membrane stabilizer taking urea and NaHCO₃ as an example accounts for 2% of the total mass of the liquid membrane, and the components are added at equal mass ratios. Taking the porous liquid membrane immobilized carrier which was activated carbon as an example, absorption was performed at temperatures of 0, 20, 40, 80, 120, and 160° C. under the conditions taking absorption space velocity=50,000 h⁻¹ and solid-liquid ratio of absorbent=1:0.5 as an example, the NOₓ concentrations at the inlet and outlet were detected and analyzed by employing a flue gas analyzer (Testo 350), and the absorption efficiency was calculated.

TABLE 6
Purification efficiency at different temperatures

| | | | | Porous | | |
|---|---|---|---|---|---|---|
| | Liquid membrane components | | | liquid | | |
| | | Liquid | Liquid | membrane | | |
| | pH value | membrane | membrane | immobilized | Temperature | Absorption |
| No. | regulator | forming agent | stabilizer | carrier | (° C.) | efficiency |
| 1 | NaOH, Na₂S, | Water, propylene | Urea, | Activated | 0 | 59.40% |
| | ethanolamine | glycol | NaHCO₃ | carbon | | |
| 2 | NaOH, Na₂S, | Water, propylene | Urea, | Activated | 20 | 74.88% |
| | ethanolamine | glycol | NaHCO₃ | carbon | | |
| 3 | NaOH, Na₂S, | Water, propylene | Urea, | Activated | 40 | 87.51% |
| | ethanolamine | glycol | NaHCO₃ | carbon | | |
| 4 | NaOH, Na₂S, | Water, propylene | Urea, | Activated | 80 | 98.82% |
| | ethanolamine | glycol | NaHCO₃ | carbon | | |
| 5 | NaOH, Na₂S, | Water, propylene | Urea, | Activated | 120 | 97.68% |
| | ethanolamine | glycol | NaHCO₃ | carbon | | |
| 6 | NaOH, Na₂S, | Water, propylene | Urea, | Activated | 160 | 99.70% |
| | ethanolamine | glycol | NaHCO₃ | carbon | | |

### Example 6

Flue gases with NOₓ concentrations of 10, 50, 100, 250, 500, 1,000, 1,500, and 2,000 mg/m³ were introduced into a flue gas oxidation device, 13.2, 66, 132, 330, 660, 1,320, 1,980, and 2,640 mg/m³ O₃ were introduced to oxidize the flue gases, and taking a volume ratio of NO₂/NO after oxidation, which was 1:0.2 as an example, the oxidized flue gas was introduced to an absorption tower to perform reactive absorption with a porous material with an immobilized liquid membrane through an absorption bed; and the liquid membrane loaded on the porous material is composed of a pH value regulator, a liquid membrane forming agent, and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent consisting of water and propylene glycol (mass ratio=1:0.2) is taken as an example. The liquid membrane stabilizer taking urea and NaHCO₃ as an example accounts for 2% of the total mass of the liquid membrane, and the components are added at equal mass ratios. Taking the porous liquid membrane immobilized carrier, which was activated carbon as an example, absorption was performed under the conditions taking 80° C., absorption space velocity=50,000 h⁻¹, and solid-liquid ratio of absorbent=1:0.5 as an example, the NOₓ concentrations at the inlet and outlet were detected and analyzed by employing a flue gas analyzer (Testo 350), and the absorption efficiency was calculated.

TABLE 7
Purification efficiency at different initial NOₓ concentrations

| | | | | Porous | | |
|---|---|---|---|---|---|---|
| | Liquid membrane components | | | liquid | | |
| | | | Liquid | membrane | NOₓ | |
| | pH value | Liquid membrane | membrane | immobilized | Concentration | Absorption |
| No. | regulator | forming agent | stabilizer | carrier | (mg/m³) | efficiency |
| 1 | NaOH, Na₂S, | Water, propylene | Urea, | Activated | 10 | 99.74% |
| | ethanolamine | glycol | NaHCO₃ | carbon | | |
| 2 | NaOH, Na₂S, | Water, propylene | Urea, | Activated | 50 | 99.84% |
| | ethanolamine | glycol | NaHCO₃ | carbon | | |
| 3 | NaOH, Na₂S, | Water, propylene | Urea, | Activated | 100 | 99.99% |
| | ethanolamine | glycol | NaHCO₃ | carbon | | |
| 4 | NaOH, Na₂S, | Water, propylene | Urea, | Activated | 250 | 98.61% |
| | ethanolamine | glycol | NaHCO₃ | carbon | | |
| 5 | NaOH, Na₂S, | Water, propylene | Urea, | Activated | 500 | 98.82% |
| | ethanolamine | glycol | NaHCO₃ | carbon | | |
| 6 | NaOH, Na₂S, | Water, propylene | Urea, | Activated | 1,000 | 86.03% |
| | ethanolamine | glycol | NaHCO₃ | carbon | | |
| 7 | NaOH, Na₂S, | Water, propylene | Urea, | Activated | 1,500 | 89.81% |
| | ethanolamine | glycol | NaHCO₃ | carbon | | |
| 8 | NaOH, Na₂S, | Water, propylene | Urea, | Activated | 2,000 | 74.08% |
| | ethanolamine | glycol | NaHCO₃ | carbon | | |

### Example 7

Taking a flue gas with a NOₓ concentration of 500 mg/m³ as an example, the flue gas was introduced into a flue gas oxidation device, the volume ratios of NO₂/NO after oxidation were respectively 1:100, 1:50, 1:25, 1:10, 1:5, 1:1, 1:0.5, 1:0.2, 1:0.1, 1:0.05, 1:0.02, and 1:0.01, 8, 16, 32, 72, 133, 400, 530, 660, 730, 760, 780, and 800 mg/m³ O₃ were respectively introduced to oxidize the flue gas, and the oxidized flue gas was introduced to an absorption tower to perform reactive absorption with a porous material with an immobilized liquid membrane through an absorption bed. The liquid membrane loaded on the porous material is composed of three parts: a pH value regulator, a liquid membrane forming agent and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent consisting of water and propylene glycol (mass ratio=1:0.2) is taken as an example. The liquid membrane stabilizer taking urea and NaHCO₃ as an example accounts for 2% of the total mass of the liquid membrane, and the components are added at equal mass ratios. Taking the porous liquid membrane immobilized carrier which was activated carbon as an example, absorption was performed under the conditions taking 80° C., absorption space velocity=50,000 h⁻¹, and solid-liquid ratio of absorbent=1:0.5 as an example, the NOₓ concentrations at the inlet and outlet were detected and analyzed by employing a flue gas analyzer (Testo 350), and the absorption efficiency was calculated.

TABLE 8
Purification efficiency at different NO₂/NO (different degrees of oxidation)

| | Liquid membrane components | | | Porous liquid | | |
|---|---|---|---|---|---|---|
| | | Liquid | Liquid | membrane | | |
| | pH value | membrane | membrane | immobilized | Oxidized | Absorption |
| No. | regulator | forming agent | stabilizer | carrier | NO₂/NO | efficiency |
| 1 | NaOH, Na₂S, | Water, propylene | Urea, | Activated | 1:100 | 28.80% |
| | ethanolamine | glycol | NaHCO₃ | carbon | | |
| 2 | NaOH, Na₂S, | Water, propylene | Urea, | Activated | 1:50 | 36.90% |
| | ethanolamine | glycol | NaHCO₃ | carbon | | |
| 3 | NaOH, Na₂S, | Water, propylene | Urea, | Activated | 1:25 | 44.95% |
| | ethanolamine | glycol | NaHCO₃ | carbon | | |
| 4 | NaOH, Na₂S, | Water, propylene | Urea, | Activated | 1:10 | 51.74% |
| | ethanolamine | glycol | NaHCO₃ | carbon | | |
| 5 | NaOH, Na₂S, | Water, propylene | Urea, | Activated | 1:5 | 66.71% |
| | ethanolamine | glycol | NaHCO₃ | carbon | | |
| 6 | NaOH, Na₂S, | Water, propylene | Urea, | Activated | 1:1 | 72.96% |
| | ethanolamine | glycol | NaHCO₃ | carbon | | |
| 7 | NaOH, Na₂S, | Water, propylene | Urea, | Activated | 1:0.5 | 82.06% |
| | ethanolamine | glycol | NaHCO₃ | carbon | | |
| 8 | NaOH, Na₂S, | Water, propylene | Urea, | Activated | 1:0.2 | 98.82% |
| | ethanolamine | glycol | NaHCO₃ | carbon | | |
| 9 | NaOH, Na₂S, | Water, propylene | Urea, | Activated | 1:0.1 | 98.06% |
| | ethanolamine | glycol | NaHCO₃ | carbon | | |
| 10 | NaOH, Na₂S, | Water, propylene | Urea, | Activated | 1:0.05 | 90.02% |
| | ethanolamine | glycol | NaHCO₃ | carbon | | |
| 11 | NaOH, Na₂S, | Water, propylene | Urea, | Activated | 1:0.02 | 98.58% |
| | ethanolamine | glycol | NaHCO₃ | carbon | | |
| 12 | NaOH, Na₂S, | Water, propylene | Urea, | Activated | 1:0.01 | 98.79% |
| | ethanolamine | glycol | NaHCO₃ | carbon | | |

### Example 8

Taking a flue gas with a NOₓ concentration of 500 mg/m³ as an example, the flue gas was introduced into a flue gas oxidation device, 660 mg/m³ O₃ was introduced to oxidize the flue gas, and taking a volume ratio of NO₂/NO after oxidation, which was 1:0.2 as an example, the oxidized flue gas was introduced to an absorption tower to perform reactive absorption with a porous material with an immobilized liquid membrane through an absorption bed. The liquid membrane loaded on the porous material is composed of three parts: a pH value regulator, a liquid membrane forming agent and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent consisting of water and propylene glycol (mass ratio=1:0.2) is taken as an example. The liquid membrane stabilizer taking urea and NaHCO₃ as an example accounts for 2% of the total mass of the liquid membrane, and the components are added at equal mass ratios. Taking the porous liquid membrane immobilized carrier which was activated carbon as an example, absorption was performed at absorption space velocities of 1,000, 2,500, 5,000, 10,000, 25,000, 50,000, 100,000, 250,000, 500,000, and 1,000,000 h⁻¹ under the conditions taking 80° C. and solid-liquid ratio of absorbent=1:0.5 as an example, the NOₓ concentrations at the inlet and outlet were detected and analyzed by employing a flue gas analyzer (Testo 350), and the absorption efficiency was calculated.

TABLE 9
Purification efficiency at different absorption space velocities

| | Liquid membrane components | | | Porous liquid | | |
|---|---|---|---|---|---|---|
| | | | Liquid | membrane | Space | |
| | pH value | Liquid membrane | membrane | immobilized | velocity | Absorption |
| No. | regulator | forming agent | stabilizer | carrier | (h⁻¹) | efficiency |
| 1 | NaOH, Na₂S, | Water, propylene | Urea, | Activated | 1,000 | 99.46% |
| | ethanolamine | glycol | NaHCO₃ | carbon | | |
| 2 | NaOH, Na₂S, | Water, propylene | Urea, | Activated | 2,500 | 98.26% |
| | ethanolamine | glycol | NaHCO₃ | carbon | | |
| 3 | NaOH, Na₂S, | Water, propylene | Urea, | Activated | 5,000 | 98.33% |
| | ethanolamine | glycol | NaHCO₃ | carbon | | |
| 4 | NaOH, Na₂S, | Water, propylene | Urea, | Activated | 10,000 | 97.71% |
| | ethanolamine | glycol | NaHCO₃ | carbon | | |
| 5 | NaOH, Na₂S, | Water, propylene | Urea, | Activated | 25,000 | 98.58% |
| | ethanolamine | glycol | NaHCO₃ | carbon | | |
| 6 | NaOH, Na₂S, | Water, propylene | Urea, | Activated | 50,000 | 98.82% |
| | ethanolamine | glycol | NaHCO₃ | carbon | | |
| 7 | NaOH, Na₂S, | Water, propylene | Urea, | Activated | 100,000 | 88.56% |
| | ethanolamine | glycol | NaHCO₃ | carbon | | |
| 8 | NaOH, Na₂S, | Water, propylene | Urea, | Activated | 250,000 | 86.15% |
| | ethanolamine | glycol | NaHCO₃ | carbon | | |
| 9 | NaOH, Na₂S, | Water, propylene | Urea, | Activated | 500,000 | 86.02% |
| | ethanolamine | glycol | NaHCO₃ | carbon | | |
| 10 | NaOH, Na₂S, | Water, propylene | Urea, | Activated | 1,000,000 | 74.67% |
| | ethanolamine | glycol | NaHCO₃ | carbon | | |

### Example 9

Taking a flue gas with a NOₓ concentration of 500 mg/m³ as an example, the flue gas was introduced into a flue gas oxidation device, 660 mg/m³ O₃ was introduced to oxidize the flue gas, and taking a volume ratio of NO₂/NO after oxidation, which was 1:0.2 as an example, the oxidized flue gas was introduced to an absorption tower to perform reactive absorption with a porous material with an immobilized liquid membrane through an absorption bed. The liquid membrane loaded on the porous material is composed of three parts: a pH value regulator, a liquid membrane forming agent and a liquid membrane stabilizer.

The pH regulator taking three substances: NaOH, Na₂S, and ethanolamine as an example accounts for 5% of the total mass of the liquid membrane, and the components are added at equal mass ratios. The liquid membrane forming agent consisting of water and propylene glycol (mass ratio=1:0.2) is taken as an example. The liquid membrane stabilizer taking urea and NaHCO₃ as an example accounts for 2% of the total mass of the liquid membrane, and the components are added at equal mass ratios. Taking the porous liquid membrane immobilized carrier which was activated carbon as an example, absorption was performed at absorption space velocities of 1,000, 2,500, 5,000, 10,000, 25,000, 50,000, 100,000, 250,000, 500,000, and 1,000,000 h⁻¹ under the conditions taking 80° C., absorption space velocity=50,000 h⁻¹, and solid-liquid ratio of absorbent=1:10, 1:5, 1:1, 1:0.5, 1:0.2, 1:0.1, and 1:0.05 as an example, the NOₓ concentrations at the inlet and outlet were detected and analyzed by employing a flue gas analyzer (Testo 350), and the absorption efficiency was calculated.

TABLE 10
Purification efficiency at different solid-liquid ratios of absorbent

| | Liquid membrane components | | | Porous liquid | Solid- | |
|---|---|---|---|---|---|---|
| | | | Liquid | membrane | liquid | |
| | pH value | Liquid membrane | membrane | immobilized | ratio of | Absorption |
| No. | regulator | forming agent | stabilizer | carrier | absorbent | efficiency |
| 1 | NaOH, Na₂S, | Water, propylene | Urea, | Activated | 1:10 | 72.40% |
| | ethanolamine | glycol | NaHCO₃ | carbon | | |
| 2 | NaOH, Na₂S, | Water, propylene | Urea, | Activated | 1:5 | 82.62% |
| | ethanolamine | glycol | NaHCO₃ | carbon | | |
| 3 | NaOH, Na₂S, | Water, propylene | Urea, | Activated | 1:1 | 87.15% |
| | ethanolamine | glycol | NaHCO₃ | carbon | | |
| 4 | NaOH, Na₂S, | Water, propylene | Urea, | Activated | 1:0.5 | 98.82% |
| | ethanolamine | glycol | NaHCO₃ | carbon | | |
| 5 | NaOH, Na₂S, | Water, propylene | Urea, | Activated | 1:0.2 | 95.77% |
| | ethanolamine | glycol | NaHCO₃ | carbon | | |
| 6 | NaOH, Na₂S, | Water, propylene | Urea, | Activated | 1:0.1 | 92.73% |
| | ethanolamine | glycol | NaHCO₃ | carbon | | |
| 7 | NaOH, Na₂S, | Water, propylene | Urea, | Activated | 1:0.05 | 87.77% |
| | ethanolamine | glycol | NaHCO₃ | carbon | | |

In conclusion, the method for absorbing NO₂ provided by this patent is high in NO₂ removal efficiency, low in energy consumption due to the low-temperature normal pressure reaction, and is quite promising in terms of industrial denitration.

The contents described in this specification are merely enumerations of the implementation forms of the inventive concept, and the protection scope of the present disclosure shall not be deemed to be limited only to the specific forms stated in the embodiments.

What is claimed is:

1. A method for purifying nitrogen oxide waste gases, comprising using ozone, ClO₂ or O₂ to partially oxidize a NOₓ-containing flue gas with different initial concentrations and convert a NOₓ component in the flue gas to a NO₂—NO mixed flue gas, which is then passed into an absorption bed filled with an absorption material, to absorb and remove nitrogen oxides; wherein
the absorption material comprises a porous solid phase material and a liquid membrane loaded thereon, a mass ratio of the porous solid phase material to the liquid membrane is 1:(0.05-0.5);
the liquid membrane is primarily composed of three parts: a pH value regulator, a liquid membrane forming agent, and a liquid membrane stabilizer, wherein in percent by weight, the liquid membrane comprises: 4.8-5.5% of the pH value regulator, 1-2% of the liquid membrane stabilizer, and the remaining is the liquid membrane forming agent;
the pH value regulator comprises an organic base and an inorganic base, wherein a mass ratio of the organic base to the inorganic base is 1:(0.65-1); and the organic base is an organic amine, and the inorganic base is one or more of NaOH, Na₂CO₃, KOH, K₂CO₃, and Na₂S;
the liquid membrane stabilizer comprises urea and an additive, wherein a mass ratio of the urea to the additive is 1:(0.5-1), and the additive is one or more of NaCl, CaCl₂), NaHCO₃, EDTA, and Na₂SO₃;
in components of the liquid membrane forming agent, a mass ratio of water to C1-C4 lower alcohols is 1:(0.1-0.3), and the C1-C4 lower alcohols are propylene glycol; and
the porous solid phase material is activated carbon, with a specific surface area greater than 500 m²/g.

2. The method for purifying nitrogen oxide waste gases according to claim 1, wherein the additive is NaHCO₃.

3. The method for purifying nitrogen oxide waste gases according to claim 1, wherein in the components of the liquid membrane forming agent, the mass ratio of the water to the C1-C4 lower alcohols is 1:0.2.

4. The method for purifying nitrogen oxide waste gases according to claim 1, wherein the specific surface area of the porous solid-phase material is greater than 1,000 m²/g.

5. The method for purifying nitrogen oxide waste gases according to claim 1, wherein the initial NOₓ concentration of the NOₓ-containing flue gas is 10-2,000 mg/m³; a post-oxidation NO₂/NO volume ratio in the flue gas is 1:(5-0.01); and an absorption temperature is 40-160° C., and an absorption space velocity is 1,000-500,000 h⁻¹.

6. The method for purifying nitrogen oxide waste gases according to claim 5, wherein the initial NOₓ concentration of the NOₓ-containing flue gas is 50-1500 mg/m³; the post-oxidation NO₂/NO volume ratio in the flue gas is 1:(1-0.1); and an absorption temperature is 40-120° C., and an absorption space velocity is 1,000-200,000 h⁻¹.
